(19) United States
(12) Patent Application Publication
(10) Pub. No.: US 2026/0051637 A1
(43) Pub. Date: Feb. 19, 2026

(54) SECONDARY BATTERY AND MANUFACTURING METHOD OF SECONDARY BATTERY

(71) Applicant: SAMSUNG SDI CO., LTD., Yongin-si (KR)

(72) Inventor: Taewoong JANG, Yongin-si (KR)

(21) Appl. No.: 19/011,745

(22) Filed: Jan. 7, 2025

(30) Foreign Application Priority Data
Aug. 13, 2024 (KR) 10-2024-0108358

(51) Int. Cl. H01M 50/586; H01M 10/04; H01M 50/109; H01M 50/153; H01M 50/536; H01M 50/564; H01M 50/595

(52) U.S. Cl. CPC H01M 50/586; H01M 10/0431; H01M 50/109; H01M 50/153; H01M 50/536; H01M 50/564; H01M 50/595

(57) ABSTRACT

A secondary battery, including an electrode assembly configured by winding a first electrode, a second electrode, and a separator provided between the first electrode and the second electrode, a case having an opening on one side, the case accommodating the electrode assembly therein, an electrode tab joined to the first electrode, a cap assembly joined to the one side of the case to seal the opening, the cap assembly including a terminal plate electrically connected to the first electrode, and a cover tape covering a first side of the electrode tab adjacent to the terminal plate, the cover tape electrically connecting and joining the electrode tab and the terminal plate.

### CROSS-REFERENCE TO RELATED APPLICATION

This application claims priority under 35 U.S.C § 119 to Korean Patent Application No. 10-2024-0108358, filed in the Korean Intellectual Property Office on Aug. 13, 2024, the entire contents of which are hereby incorporated by reference.

### BACKGROUND

### 1. Field

Embodiments relate to a secondary battery and a method for manufacturing the secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include a secondary battery, including an electrode assembly configured by winding a first electrode, a second electrode, and a separator provided between the first electrode and the second electrode, a case having an opening on one side, the case accommodating the electrode assembly therein, an electrode tab joined to the first electrode, a cap assembly joined to the one side of the case to seal the opening, the cap assembly including a terminal plate electrically connected to the first electrode, and a cover tape covering a first side of the electrode tab adjacent to the terminal plate, the cover tape electrically connecting and joining the electrode tab and the terminal plate.

The cover tape may include an adhesive portion including an insulating material, and conductive particles distributed inside the adhesive portion.

The cover tape may be heat-compressed, laser-compressed, or ultrasonically compressed between the electrode tab and the terminal plate, the conductive particles electrically connecting the electrode tab and the terminal plate.

The cover tape may be heat-compressed, laser-compressed, or ultrasonically compressed between the electrode tab and the terminal plate, the adhesive portion joining the electrode tab and the terminal plate.

An area of the cover tape may be larger than an area of the electrode tab.

The cover tape may include a double-sided adhesive film having a thickness of 15 μm to 35 μm.

The electrode tab may be welded to the first electrode, and the cover tape may cover an entire area of the first electrode including a welded portion thereof.

The secondary battery may further include an insulating tape attached to a second side opposite to the first side of the electrode tab, the insulating tape covering the first electrode.

The first electrode may be joined to the electrode tab through the cover tape attached to the electrode tab.

The first electrode is joined to a second side of the electrode tab facing the first side of the electrode tab through heat compression, laser compression, or ultrasonic compression.

Embodiments include a method for manufacturing a secondary battery, the method including preparing an electrode assembly by winding a first electrode, a second electrode, and a separator interposed between the first electrode and the second electrode, connecting an electrode tab to the first electrode, accommodating the electrode assembly in a case having an opening on one side, preparing a cap assembly including a terminal plate, attaching a cover tape to a first side of the electrode tab, and joining the electrode tab to the terminal plate by compressing a second side of the electrode tab opposite to the first side of the electrode tab.

The cover tape may include an adhesive portion formed of an insulating material, and conductive particles distributed inside the adhesive portion.

Joining the electrode tab to the terminal plate may include heat-compressing, laser-compressing, or ultrasonically compressing the cover tape between the electrode tab and the terminal plate, the conductive particles electrically connecting the electrode tab and the terminal plate.

Joining the electrode tab to the terminal plate may include heat-compressing, laser-compressing, or ultrasonically compressing the cover tape between the electrode tab and the terminal plate, the adhesive portion joining the electrode tab and the terminal plate.

An area of the cover tape may be larger than an area of the electrode tab.

The cover tape may be a double-sided adhesive film having a thickness of 15 μm to 35 μm.

Connecting the electrode tab to the first electrode may include welding the electrode tab to the first electrode, wherein the cover tape covers an entire area of the first electrode including a welded portion thereof.

Connecting the electrode tab to the first electrode may include attaching an insulating tape to the second side of the electrode tab to which the first electrode is joined.

The method may further include joining the first electrode to the electrode tab through the cover tape attached to the electrode tab.

Connecting the electrode tab to the first electrode may include heat-compressing, laser-compressing, or ultrasonically compressing the second side of the electrode tab.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of skill in the art by describing in detail exemplary embodiments with reference to the attached drawings, in which:

FIG. 1 illustrates a perspective view of a secondary battery according to one or more embodiments of the present disclosure;

FIG. 2 illustrates an exploded perspective view of the secondary battery of FIG. 1 according to one or more embodiments of the present disclosure;

FIG. 3 illustrates a state before a cap assembly of a secondary battery according to one or more embodiments of the present disclosure is joined to a case;

FIG. 4 illustrates a state before a cover tape is attached to an electrode tab of a secondary battery according to one or more embodiments of the present disclosure;

FIG. 5 illustrates a cross-sectional view of the secondary battery according to one or more embodiments of the present disclosure;

FIG. 6 illustrates an enlarged view of region B of FIG. 5;

FIG. 7 illustrates a state in which an electrode tab is joined to a first electrode in the embodiment of FIG. 5;

FIG. 8 illustrates a state in which a cover tape is joined to an electrode tab in FIG. 7;

FIG. 9 illustrates a cross-sectional view of a secondary battery according to one or more other embodiments of the present disclosure;

FIG. 10 illustrates an enlarged view of region C of FIG. 9;

FIG. 11 illustrates an electrode tab joined to a first electrode through a cover tape in the embodiment of FIG. 9;

FIG. 12 illustrates a cross-sectional view showing a state before a cover tape is compressed according to one or more embodiments of the present disclosure;

FIG. 13 illustrates a cross-sectional view showing a state after a cover tape is compressed according to one or more embodiments of the present disclosure; and

FIG. 14 illustrates a flowchart showing a method for manufacturing a secondary battery according to one or more embodiments of the present disclosure.

### DETAILED DESCRIPTION

Example embodiments described herein may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

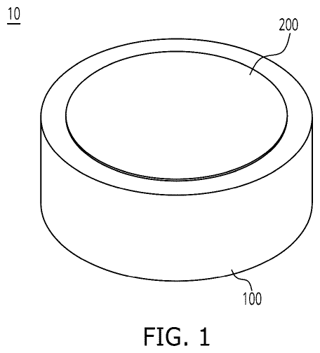

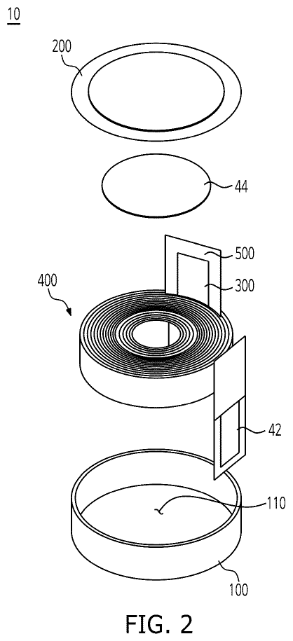

FIG. 1 illustrates a perspective view of a secondary battery according to one or more embodiments of the present disclosure, and FIG. 2 illustrates an exploded perspective view of the secondary battery of FIG. 1 according to one or more embodiments of the present disclosure.

As illustrated in FIGS. 1 and 2, the secondary battery 10 may include a case 100, a cap assembly 200, an electrode tab 300, an electrode assembly 400, and a cover tape 500.

In one or more embodiments, the secondary battery 10 may be a coin-type or button-type secondary battery. For example, the secondary battery 10 may have a cylindrical shape, but the shape of the secondary battery 10 may vary.

In one or more embodiments, the case 100 may have an opening 110 formed on one side, the case 100 accommodating the electrode assembly 400 therein. The case 100 may accommodate the electrode assembly 400 and an electrolyte, and may configure (e.g., define) the external appearance of the secondary battery together with the cap assembly 200. The case 100 may include an approximately cylindrical sidewall portion and a bottom portion connected to one side of the sidewall portion. However, the shape or structure of the case 100 may be configured in various shapes such as a circular shape and a pouch shape. For example, the case 100 may include metal such as aluminum, an aluminum alloy, stainless steel, or nickel-plated steel, or a laminated film or plastic that constitutes a pouch.

The case 100 may accommodate the electrode assembly 400. The electrode assembly 400 may be inserted into the case 100 through the opening 110 formed in one side thereof. Thereafter, the opening 110 of the case 100 may be closed by the cap assembly 200. The cap assembly 200 may be joined to the one side of the case 100.

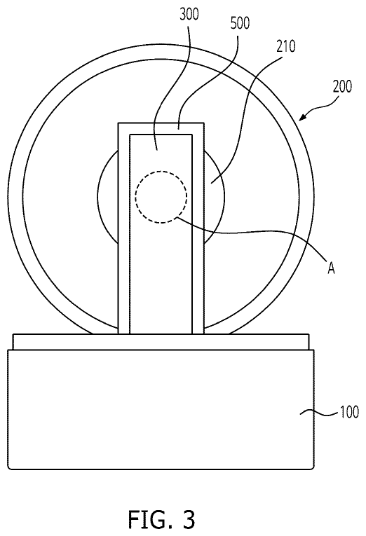

The cap assembly 200 may be joined to one side of the case 100 to seal the opening 110 and may include a terminal plate (e.g., 210 in FIG. 3) electrically connected to the electrode tab 300. The cap assembly 200 may be welded to an area that comes into contact with or is joined to the case 100. In one or more embodiments, the cap assembly 200 may include a cap plate, an insulating layer, and a terminal plate 210. The cap plate may seal the opening 110 of the case 100. The cap plate may be joined to the side surface of the case 100 corresponding to the side surface of the opening 110. An insertion hole may be formed in the cap plate. Specifically, the insertion hole may be formed approximately at the center of the cap plate. At least a portion of the terminal plate 210 may be inserted into the insertion hole and joined to the cap plate while an insulating layer is interposed between the terminal plate 210 and the cap plate.

The electrode assembly 400 may include a first electrode, a second electrode, and a separator. Specifically, the electrode assembly 400 may be configured by winding a first electrode, a second electrode, and a separator interposed between the first electrode and the second electrode. The electrode assembly 400 may be wound to form a core portion and may include a through-hole in the core portion.

The first electrode may include a first substrate and a first active material layer positioned (e.g., applied) on the first substrate. The electrode tab 300 may extend outward from a first uncoated portion of the first substrate where the first active material layer is not positioned, and the electrode tab 300 may be electrically connected to the terminal plate 210 of the cap assembly 200. In one or more embodiments, the electrode tab 300 may be a positive electrode tab. The electrode tab 300 may be joined to the first electrode.

The second electrode may include a second substrate and a second active material layer positioned on (e.g., applied to) the second substrate. An electrode tab 42 may extend outward from a second uncoated portion of the second substrate where the second active material layer is not positioned, and the electrode tab 42 may be electrically connected to the lower inner surface of the case 100. In one or more embodiments, the electrode tab 42 may be a negative electrode tab. The electrode tab 42 may be joined to the second electrode. The electrode tab 300 and the electrode tab 42 may respectively extend outward in opposite directions from the first electrode and the second electrode.

The first electrode may function as a positive electrode. In this case, the first substrate may include, for example, aluminum foil, and the first active material layer may include, for example, a transition metal oxide. The second electrode may function as a negative electrode. In this case, the second substrate may include, for example, copper foil or nickel foil, and the second active material layer may include, for example, graphite.

The separator may function to prevent a short circuit between the first electrode and the second electrode while allowing movement of lithium ions. The separator may include, for example, polyethylene film, polypropylene film, polyethylene-polypropylene film, or the like, but the materials the separator may vary.

Referring to FIG. 2, the electrode tab 300 of the first electrode may be formed on one side of the electrode assembly 400. The electrode tab 42 of the second electrode may be formed on another side of the electrode assembly 400. However, both the electrode tab 300 and the electrode tab 42 may be formed on one side of the electrode assembly 400. For example, an insulating sheet 44 may be disposed on the electrode assembly 400 so as to insulate between the upper portion of the electrode assembly 400 and the electrode tab 300.

The cover tape 500 may cover the first side of the electrode tab 300 adjacent to the terminal plate 210. The area of the cover tape 500 may be formed to be larger than the area of the electrode tab 300. The cover tape 500 may be joined to electrically connect the electrode tab 300 and the terminal plate 210.

In one or more embodiments, the cover tape 500 may be an anisotropic conductive film (ACF) that is electrically anisotropic. The cover tape 500 may be formed as a double-sided tape in which an adhesive curable by heat and fine conductive particles are distributed therein. For example, the cover tape 500 may have a property of conducting electricity only in the thickness direction and blocking electricity in the width direction in a case of being heat-compressed.

In a case where high temperature pressure is applied to the cover tape 500, the adhesive at the contacting portion melts under the pressure, and the conductive particles come into contact with the electrode tab 300 and the terminal plate 210, so that the electrode tab 300 and the terminal plate 210 may be electrically connected. For example, in a case where the surrounding temperature is lowered, the adhesive of the cover tape 500 is filled and cured, so that the electrode tab 300 and the terminal plate 210 may be joined to each other by the cured adhesive. In this manner, the electrode tab 300 and the terminal plate 210 may be electrically interconnected with high conductivity while being joined with high adhesive strength through the cover tape 500.

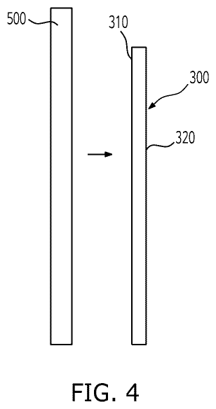

FIG. 3 illustrates a state before a cap assembly of a secondary battery according to one or more embodiments of the present disclosure is joined to a case, and FIG. 4 illustrates a state before a cover tape is attached to an electrode tab of a secondary battery according to one or more embodiments of the present disclosure.

The cap assembly 200 may be joined to an opening of one side of the case 100 while the electrode tab 300 is joined to the terminal plate 210. In this state, the cap assembly 200 may cover the upper surface of the case 100 to seal the case 100. For example, the cap assembly 200 may be welded to the case 100 while the cap assembly 200 covers the case 100.

As illustrated in FIGS. 3 and 4, the cover tape 500 may cover the first side 310 of the electrode tab 300 adjacent to the terminal plate 210. The area of the cover tape 500 may be formed to be larger than the area of the electrode tab 300. The cover tape 500 may be attached or joined to the first side 310 of the electrode tab 300. In one or more embodiments, the cover tape 500 may be a double-sided adhesive film formed to have a thickness of 15 μm to 35 μm.

In a case where the cover tape 500 is joined to the first side 310 of the electrode tab 300 and the second side 320 facing the first side 310 is compressed, the terminal plate 210 and the electrode tab 300 may be electrically connected.

As illustrated in FIG. 3, in a case where the electrode tab 300 is compressed and electrically connected and joined to the electrode tab 300 and the terminal plate 210 through the cover tape 500, the joining strength may be improved compared to the existing welding joining method. That is, in a case where the electrode tab 300 is welded to join the electrode tab 300 to the terminal plate 210, there has been a problem in that the welding area was not sufficiently secured due to the limitation of the size of the electrode tab 300. According to one or more embodiments of the present disclosure, in a case where the electrode tab 300 and the terminal plate 210 are joined using the cover tape 500 instead of welding, a sufficient compression area A may be secured, and thus, the joining strength between the electrode tab 300 and the terminal plate 210 may be improved while ensuring stable electrical connection.

In one or more embodiments, in a case where the cover tape 500 is heat-compressed, laser-compressed, or ultrasonically compressed between the electrode tab 300 and the terminal plate 210, the conductive particles of the cover tape 500 may electrically connect the electrode tab 300 and the terminal plate 210. For example, in the case of thermal compression, compression may be performed at a temperature of 100° C. to 180° C. for 1 to 20 seconds at a pressure of 1 MPa to 3 MPa.

The cover tape 500 may have high insulating properties as a non-conductor before being compressed. In this state, in a case where compression is performed on the compression area A of the electrode tab 300, the adhesive of the cover tape 500 melts and the conductive particles come into contact with the electrode tab 300 and the terminal plate 210, and the electrode tab 300 and the terminal plate 210 may be electrically connected.

In one or more embodiments, in a case where the cover tape 500 is heat-compressed, laser-compressed, or ultrasonically compressed between the electrode tab 300 and the terminal plate 210, the adhesive portion of the cover tape 500 may be joined to the electrode tab 300 and the terminal plate 210. For example, in the case of thermal compression, compression may be performed at a temperature of 100° C. to 180° C. for 1 to 20 seconds at a pressure of 1 MPa to 3 MPa. In one or more embodiments, the adhesive portion of the cover tape 500 may be heat-cured after compression is performed to improve the joining strength between the electrode tab 300 and the terminal plate 210.

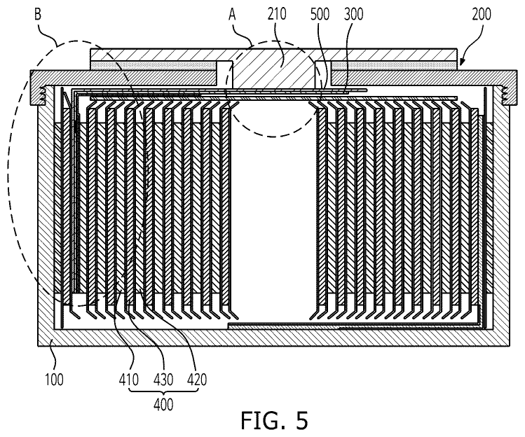

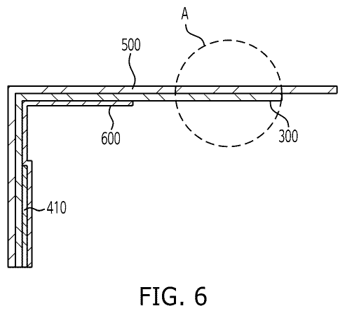

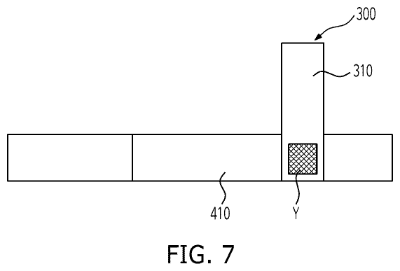

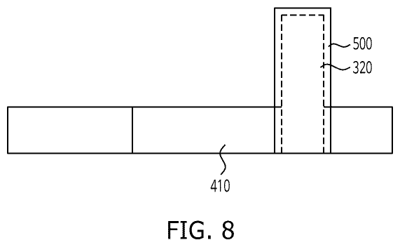

FIG. 5 illustrates a cross-sectional view of the secondary battery according to one or more embodiments of the present disclosure, FIG. 6 illustrates an enlarged view of a region B of FIG. 5, FIG. 7 illustrates a state in which an electrode tab is joined to a first electrode in the embodiment of FIG. 5, and FIG. 8 illustrates a state in which a cover tape is joined to an electrode tab in FIG. 7.

FIG. 5 illustrates a cross-sectional view showing a structure in which the secondary battery is cut in the height direction along a line crossing the center of the approximately cylindrical secondary battery. The secondary battery of FIGS. 5 to 8 may include an electrode assembly 400, a case 100 that accommodates the electrode assembly 400 and an electrolyte therein, and a cap assembly 200 that is joined to an opening of the case 100 to seal the case 100. The electrode assembly 400 may include a separator 430, a first electrode 410 and a second electrode 420 positioned with the separator 430 interposed therebetween and may be wound in a jelly-roll shape.

Referring to FIGS. 5 to 8, the electrode tab 300 may be welded to the first electrode 410, and the cover tape 500 may cover the entire area of the electrode tab 300 including a region Y welded to the first electrode 410. In one or more embodiments, as illustrated in FIG. 7, the electrode tab 300 may be welded to the first electrode 410. In a state in which the electrode tab 300 is arranged in contact with the first electrode 410, welding may be performed on the specific region Y of the first side 310 of the electrode tab 300 to connect the electrode tab 300 to the first electrode 410. Thereafter, as illustrated in FIG. 8, the cover tape 500 may be bonded to the first side 310 of the electrode tab 300. The cover tape 500 may cover the entire area of the first side 310 of the electrode tab 300.

In a case where compression is applied to the compression area A while the cover tape 500 is bonded to the first side 310 of the electrode tab 300, the electrode tab 300 and the terminal plate 210 may be electrically connected and mutually joined to each other.

In one or more embodiments, the secondary battery may further include an insulating tape 600 bonded to the second side opposite to the first side 310 of the electrode tab 300 and covering the first electrode 410. The insulating tape 600 may cover the second side facing the first side 310 of the electrode tab 300. The insulating tape 600 may include an insulating material. The insulating material may provide electrical insulation to prevent current from passing therethrough. A short circuit that may occur between the electrode tab 300 and a conductive component (e.g., an electrode or an uncoated portion of the electrode assembly 400) surrounding the electrode tab 300 may be prevented by the insulating tape 600.

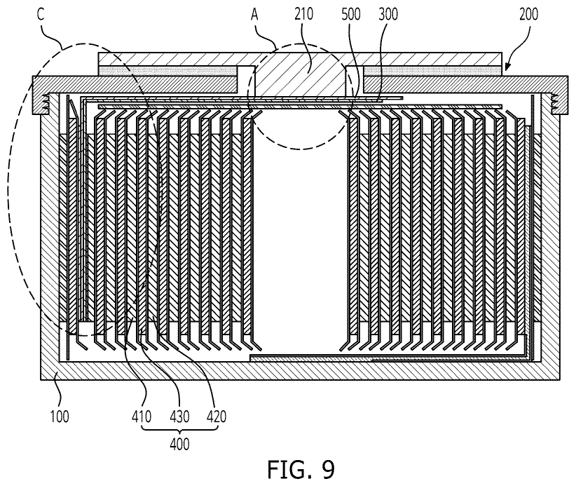

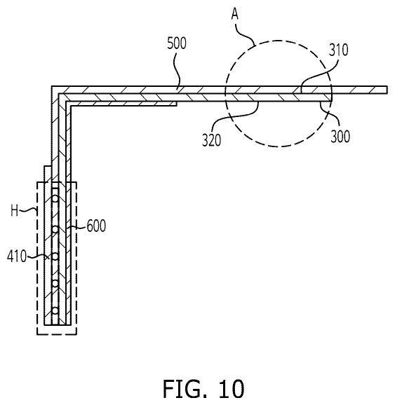

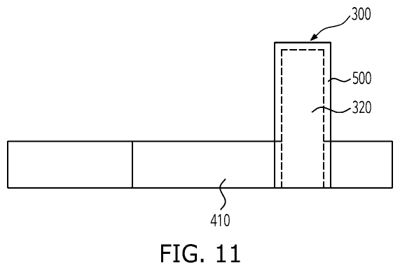

FIG. 9 illustrates a cross-sectional view of a secondary battery according to one or more other embodiments of the present disclosure, FIG. 10 illustrates an enlarged view of a region C of FIG. 9, and FIG. 11 illustrates an electrode tab joined to a first electrode through a cover tape in the embodiment of FIG. 9.

FIG. 9 illustrates a cross-sectional view showing a structure in which the secondary battery is cut in the height direction along a line crossing the center of the approximately cylindrical secondary battery. The secondary battery of FIGS. 9 to 11 may include an electrode assembly 400, a case 100 that accommodates the electrode assembly 400 and an electrolyte therein, and a cap assembly 200 that is joined to an opening of the case 100 to seal the case 100. The electrode assembly 400 may include a separator 430, a first electrode 410 and a second electrode 420 positioned with the separator 430 interposed therebetween and may be wound in a jelly-roll shape.

Referring to FIGS. 9 to 11, the first electrode 410 may be joined to an electrode tab 300 through a cover tape 500 attached to the electrode tab 300. The cover tape 500 may cover the entire area of the electrode tab 300. In one or more embodiments, as illustrated in FIG. 10, the first electrode 410 may be joined to the electrode tab 300 through the cover tape 500. For example, while the cover tape 500 is temporarily attached to the first side 310 of the electrode tab 300, the cover tape 500 may be arranged in contact with the first electrode 410, and compression may be performed on the second side 320 of the electrode tab 300 so that the electrode tab 300 may be joined to the first electrode 410 through the cover tape 500.

In a case where the first electrode 410 is in contact with one side of the cover tape 500 attached to the electrode tab 300 and compression is applied to the compression area H of the second side of the electrode tab 300 corresponding to the position where the first electrode 410 is in contact, the electrode tab 300 and the first electrode 410 may be mutually joined to each other.

For example, in a case where compression is applied to the compression area A while the cover tape 500 is bonded to the first side 310 of the electrode tab 300, the electrode tab 300 and the terminal plate 210 may be electrically connected and mutually joined to each other.

In the present embodiment, the secondary battery may further include an insulating tape 600 bonded to the second side 320 opposite to the first side 310 of the electrode tab 300 and covering the first electrode 410. The insulating tape 600 may cover the second side 320 facing the first side 310 of the electrode tab 300. The insulating tape 600 may include an insulating material. The insulating material may provide electrical insulation to prevent current from passing therethrough. A short circuit that may occur between the electrode tab 300 and the conductive components surrounding the electrode tab 300 may be prevented by the insulating tape 600.

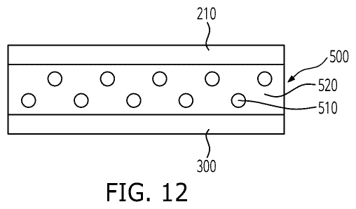

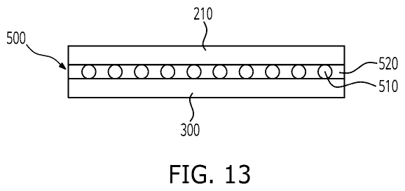

FIG. 12 illustrates a cross-sectional view showing a state before the cover tape is compressed according to one or more embodiments of the present disclosure, and FIG. 13 illustrates a cross-sectional view showing a state after the cover tape is compressed according to one or more embodiments of the present disclosure.

Referring to FIGS. 12 and 13, the cover tape 500 may include an adhesive portion 520 formed of an insulating material and conductive particles 510 distributed inside the adhesive portion 520. In one or more embodiments, the cover tape 500 may be an ACF (Anisotropic Conductive Film) that is electrically anisotropic.

For example, the adhesive portion 520 may be a thermoplastic adhesive, such as a PP-based or PE-based adhesive. In some embodiments, the adhesive portion 520 may be a thermosetting adhesive, such as an epoxy-based adhesive, a polyurethane-based adhesive, or an acrylic-based adhesive. In one or more embodiments, the adhesive portion 520 may be an adhesive formed of a material that is a mixture of a thermoplastic adhesive and a thermosetting adhesive.

For example, the conductive particles 510 may be metal particles, carbon particles, metal film-coated plastic particles, or insulating film-coated particles. The cover tape 500 may be formed by adding a dispersant, such as silica, as well as the adhesive portion 520 and the conductive particles 510.

The cover tape 500 may be formed in a double-sided tape state including the conductive particles 510 distributed inside the adhesive portion 520. For example, the cover tape 500 may have a property of conducting electricity only in the thickness direction and blocking electricity in the width direction.

In a case where high temperature and pressure are applied to the cover tape 500, the adhesive portion 520 at the contacting portion melts under the pressure, and the conductive particles 510 come into contact with the electrode tab 300 and the terminal plate 210, so that the electrode tab 300 and the terminal plate 210 may be electrically connected.

For example, the adhesive portion 520 of the cover tape 500 may be filled and cured so that the electrode tab 300 and the terminal plate 210 may be bonded to each other. In this manner, the electrode tab 300 and the terminal plate 210 may be electrically interconnected with high conductivity while being joined with high adhesive strength through the cover tape 500.

In one or more embodiments, the adhesive portion 520 may have a thickness of 10 μm to 25 μm and may be formed of an insulating material, and the conductive particles 510 may have a diameter of 5 μm to 20 μm and may be a sphere or particle formed of a metallic material. With this configuration, in a case where the cover tape 500 is arranged between the electrode tab 300 and the terminal plate 210 and then the electrode tab 300 and the terminal plate 210 are pressurized and heated, the adhesive portion 520 melts and the plurality of conductive particles 510 come into contact with the electrode tab 300 and the terminal plate 210 and are electrically connected to each other. In a case where the heating is stopped and the temperature is cooled below a certain level, the melted adhesive portion 520 may be cooled, thereby physically joining the electrode tab 300 and the terminal plate 210.

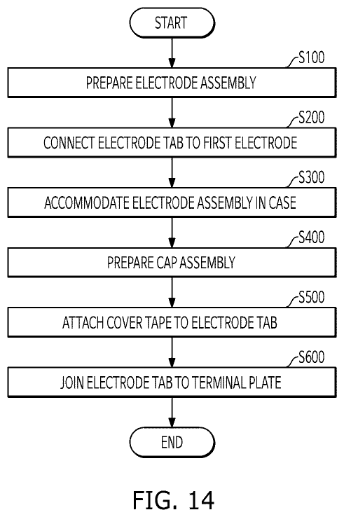

FIG. 14 illustrates a flowchart showing a method for manufacturing a secondary battery according to one or more embodiments of the present disclosure.

Referring to FIG. 14, a method for manufacturing a secondary battery according to one or more embodiments of the present disclosure may include: a step S100 of preparing an electrode assembly; a step S200 of connecting the electrode tab to a first electrode; a step S300 of accommodating the electrode assembly in a case; a step S400 of preparing a cap assembly; a step S500 of attaching a cover tape to a first side of the electrode tab; and a step S600 of joining the electrode tab to the terminal plate.

In one or more embodiments, in the step S100 of preparing the electrode assembly, an electrode assembly configured by winding a first electrode, a second electrode, and a separator interposed between the first electrode and the second electrode may be prepared.

In one or more embodiments, the step S200 of connecting the electrode tab to the first electrode may include welding the electrode tab to the first electrode. The cover tape may cover an entire area including a welded portion of the first electrode.

For example, the step S200 of connecting the electrode tab to the first electrode may include attaching an insulating tap to the second side of the electrode tab to which the first electrode is joined.

The method for manufacturing the secondary battery according to one or more other embodiments of the present disclosure may further include a step of joining the first electrode to the electrode tab through a cover tape attached to the electrode tab. At this time, the step of connecting the electrode tab to the first electrode may include heat-compressing, laser-compressing, or ultrasonically compressing the second side of the electrode tab.

In one or more embodiments, in the step S300 of accommodating the electrode assembly in the case, the electrode assembly may be accommodated in a case having an opening formed on one side. In the step S400 of preparing the cap assembly, the cap assembly including a terminal plate may be prepared.

In the step S500 of attaching the cover tape to the first side of the electrode tab, the cover tape may include an adhesive portion form of an insulating material and conductive particles distributed inside the adhesive portion.

The area of the cover tape may be formed to be larger than the area of the electrode tab. For example, the cover tape may be a double-sided adhesive film formed to have a thickness of 15 μm to 35 μm.

In the step S600 of joining the electrode tab to the terminal plate, the electrode tab may be joined to the terminal plate by compressing the second side opposite to the first surface of the electrode tab.

The step S600 of joining the electrode tab to the terminal plate may include heat-compressing, laser-compressing, or ultrasonically compressing the cover tape between the electrode tab and the terminal plate, so that the conductive particles electrically connect the electrode tab and the terminal plate.

For example, the step S600 of joining the electrode tab to the terminal plate may include heat-compressing, laser-compressing, or ultrasonically compressing the cover tape between the electrode tab and the terminal plate, so that the adhesive portion joins the electrode tab and the terminal plate.

In a case of joining components of a secondary battery, welding is mainly performed. In coin cells, energization is achieved by welding a positive electrode tab and a positive electrode terminal. In this case, there has been a problem that in a case where a positive electrode tab was floating, stress was concentrated on a welded, and cracks easily occurred in the positive electrode tab in a case of being vibrated or dropped, and the performance of the secondary battery deteriorated.

In addition, in a case where a positive electrode terminal and a positive electrode tab of a cap assembly in a coin cell are connected by welding, sharp burr on the side edge of the positive electrode tab comes into contact with the cap plate of the cap assembly. This causes damage to an insulating layer of the cap plate due to shrinkage/expansion or vibration/dropping of the electrode assembly, resulting in a short circuit.

In a case where two materials for different electrodes in a secondary battery come into electrical contact with each other and thus an internal circuit short occurs, the temperature of the secondary battery may rapidly increase, and in serious cases, it may lead to a fire.

According to various embodiments of the present disclosure, in a case where the positive electrode tab and the terminal plate are attached by welding in the secondary battery, the deterioration of the attachment strength due to stress concentration at the welded may be improved.

According to various embodiments of the present disclosure, cracks in the positive electrode tab that may occur due to welding of the positive electrode tab and the terminal plate in the secondary battery may be prevented.

According to various embodiments of the present disclosure, damage to the insulating layer of the cap plate that may occur due to welding of the positive electrode tab and the terminal plate in the secondary battery may be prevented.

According to various embodiments of the present disclosure, in a case where the cover tape for protecting the positive electrode tab is attached to the front side of the positive electrode tab, the positive electrode tab and the terminal plate may be electrically connected while protecting the entire surface of the positive electrode tab, in case the positive electrode tab and the terminal plate cannot be attached by welding.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF SOME REFERENCE SYMBOLS

10: secondary battery
110: case
110: opening
200: cap assembly
210: terminal plate
300: electrode tab
400: electrode assembly
500: cover tape
510: adhesive portion
520: conductive particles
600: insulating tape

What is claimed is:

1. A secondary battery, comprising:
an electrode assembly configured by winding a first electrode, a second electrode, and a separator provided between the first electrode and the second electrode;
a case having an opening on one side, the case accommodating the electrode assembly therein;
an electrode tab joined to the first electrode;
a cap assembly joined to the one side of the case to seal the opening, the cap assembly comprising a terminal plate electrically connected to the first electrode; and
a cover tape covering a first side of the electrode tab adjacent to the terminal plate, the cover tape electrically connecting and joining the electrode tab and the terminal plate.

2. The secondary battery as claimed in claim 1, wherein the cover tape comprises:
an adhesive portion including an insulating material; and
conductive particles distributed inside the adhesive portion.

3. The secondary battery as claimed in claim 2, wherein the cover tape is heat-compressed, laser-compressed, or ultrasonically compressed between the electrode tab and the terminal plate, the conductive particles electrically connecting the electrode tab and the terminal plate.

4. The secondary battery as claimed in claim 2, wherein the cover tape is heat-compressed, laser-compressed, or ultrasonically compressed between the electrode tab and the terminal plate, the adhesive portion joining the electrode tab and the terminal plate.

5. The secondary battery as claimed in claim 1, wherein an area of the cover tape is larger than an area of the electrode tab.

6. The secondary battery as claimed in claim 2, wherein the cover tape includes a double-sided adhesive film having a thickness of 15 μm to 35 μm.

7. The secondary battery as claimed in claim 1, wherein:
the electrode tab is welded to the first electrode, and
the cover tape covers an entire area of the first electrode including a welded portion thereof.

8. The secondary battery as claimed in claim 7, further comprising an insulating tape attached to a second side opposite to the first side of the electrode tab, the insulating tape covering the first electrode.

9. The secondary battery as claimed in claim 1, wherein the first electrode is joined to the electrode tab through the cover tape attached to the electrode tab.

10. The secondary battery as claimed in claim 9, wherein the first electrode is joined to a second side of the electrode tab facing the first side of the electrode tab through heat compression, laser compression, or ultrasonic compression.

11. A method for manufacturing a secondary battery, the method comprising:
preparing an electrode assembly by winding a first electrode, a second electrode, and a separator interposed between the first electrode and the second electrode;
connecting an electrode tab to the first electrode;
accommodating the electrode assembly in a case having an opening on one side;
preparing a cap assembly including a terminal plate;
attaching a cover tape to a first side of the electrode tab; and
joining the electrode tab to the terminal plate by compressing a second side of the electrode tab opposite to the first side of the electrode tab.

12. The method as claimed in claim 11, wherein the cover tape comprises:
an adhesive portion formed of an insulating material; and
conductive particles distributed inside the adhesive portion.

13. The method as claimed in claim 12, wherein joining the electrode tab to the terminal plate comprises heat-compressing, laser-compressing, or ultrasonically compressing the cover tape between the electrode tab and the terminal plate, the conductive particles electrically connecting the electrode tab and the terminal plate.

14. The method as claimed in claim 12, wherein joining the electrode tab to the terminal plate comprises heat-compressing, laser-compressing, or ultrasonically compressing the cover tape between the electrode tab and the terminal plate, the adhesive portion joining the electrode tab and the terminal plate.

15. The method as claimed in claim 11, wherein an area of the cover tape is larger than an area of the electrode tab.

16. The method as claimed in claim 12, wherein the cover tape is a double-sided adhesive film having a thickness of 15 μm to 35 μm.

17. The method as claimed in claim 11, wherein connecting the electrode tab to the first electrode comprises welding the electrode tab to the first electrode, wherein the cover tape covers an entire area of the first electrode including a welded portion thereof

18. The method as claimed in claim 17, wherein connecting the electrode tab to the first electrode comprises attaching an insulating tape to the second side of the electrode tab to which the first electrode is joined.

19. The method as claimed in claim 11, further comprising joining the first electrode to the electrode tab through the cover tape attached to the electrode tab.

20. The method as claimed in claim 19, wherein connecting the electrode tab to the first electrode comprises heat-compressing, laser-compressing, or ultrasonically compressing the second side of the electrode tab.
